(19) United States
(12) Patent Application Publication
(10) Pub. No.: US 2023/0318052 A1
(43) Pub. Date: Oct. 5, 2023

(54) ALL SOLID-STATE BATTERY UNIT

(71) Applicant: HONDA MOTOR CO., LTD., Tokyo (JP)

(72) Inventors: Shigemitsu Akutsu, Wako-shi (JP); Shigeru Koyama, Wako-shi (JP)

(21) Appl. No.: 18/107,528

(22) Filed: Feb. 9, 2023

(30) Foreign Application Priority Data
Mar. 30, 2022 (JP) 2022-056900

(51) Int. Cl. H01M 10/42; H01M 10/48; H01M 10/44

(52) U.S. Cl. CPC H01M 10/4257; H01M 10/482; H01M 10/486; H01M 10/445; H01M 2010/4271; H01M 2220/20

(57) ABSTRACT

An all solid-state battery unit includes: a battery module in which a plurality of all solid-state battery cells are laminated; a pressurization unit configured to pressurize the battery module; and a control unit configured to control the pressurization unit, the control unit controls a pressurization force of the pressurization unit depending on either or both of a temperature of the battery module and a State of Charge of the battery module.

### CROSS-REFERENCE TO RELATED APPLICATION

Priority is claimed on Japanese Patent Application No. 2022-056900, filed Mar. 30, 2022, the content of which is incorporated herein by reference.

### BACKGROUND OF THE INVENTION

### Field of the Invention

The present application relates to an all solid-state battery unit having an all solid-state battery module where the plurality of all solid-state battery cells are laminated.

### Description of Related Art

A capacitor which supplies power to a motor, and the like is mounted in a vehicle such as EV (Electric Vehicle), HEV (Hybrid Electrical Vehicle), and the like. It is common the capacitor is provided with the plurality of secondary batteries.

As the secondary battery mounted in the EV or the HEV, a lithium ion battery (LIB) is used conventionally and widely, however, there is a fear of the overheating, ignition and the like of the lithium ion battery due to property of electrolyte. For this reason, the all solid-state battery having properties such as higher safeness, wider useable temperature range, shorter charge time, and the like compared to the conventional lithium ion battery is drawing attention.

As a manufacturing method of the all solid-state battery, for example, it is common the all solid-state battery is where a positive electrode laminated body including a positive electrode solid-state electrolyte and a positive electrode mixture and a negative electrode laminated body including a negative electrode solid-state electrolyte and a negative electrode mixture are integrated by pressure bonding. Such all solid-state battery has lower fear of overheating, ignition and the like and higher safeness by using solid-state electrolyte.

However, in order to maintain appropriate output property and filling property, it is important in the all solid-state battery to maintain a state where the positive electrode laminated body and the negative electrode laminated body are bonded by a surface pressure in an appropriate range. For example, a battery module configured to apply a restraint load by using an elastic body with respect to a laminated body where the plurality of unit cells are laminated is disclosed in Japanese published unexamined application 2019-128979 (hereinafter, Patent literature 1). A battery module configured to adjust a restraint load by using a pressure adjusting member with respect to a laminated body where the plurality of unit cells are laminated is disclosed in Japanese published unexamined application 2019-128980 (hereinafter, Patent literature 2).

### SUMMARY OF THE INVENTION

However, battery modules disclosed in Patent literature 1 and Patent literature 2 are to maintain restraint force in response to expansion and contraction of a laminated body of a unit cell. Since charge and discharge properties of the all solid-state battery are changed by temperature and State of Charge (SOC) and the like, the all solid-state battery is required to improve energy efficiency by stabilizing the charge and discharge properties in response to fluctuations of such temperature and State of Charge.

Aspects according to the present invention have been made in view of the problems described above, and an object thereof is to provide an all solid-state battery unit that can improve energy efficiency by stabilizing the charge and discharge properties in response to fluctuations of temperature and State of Charge of all solid-state battery module.

In order to solve the problems described above and achieve the object, the present invention has adopted the following aspects.

(1) An all solid-state battery unit of one aspect according to the present application includes: a battery module in which a plurality of all solid-state battery cells are laminated; a pressurization unit configured to pressurize the battery module; and a control unit configured to control the pressurization unit, wherein the control unit controls a pressurization force of the pressurization unit depending on either or both of a temperature of the battery module and a State of Charge of the battery module.

According to the above aspect (1), the internal resistance of the all solid-state battery cell is controlled so as to maximize a charge property at a charge time and a discharge property at a discharge time depending on the states such as temperature and State of Charge (SOC) of the all solid-state battery module. As a result, an all solid-state battery unit which is always stabilized even if the temperature and the State of Charge are changed can be realized.

(2) In the above aspect (1), the control unit may perform a control of decreasing the pressurization force of the pressurization unit in response to a decrease of the temperature of the battery module.

(3) In the above aspect (1), the control unit may perform a control of increasing the pressurization force of the pressurization unit in response to a decrease of the State of Charge of the battery module.

(4) In any one of the above aspects (1) to (3), the control unit may have a fluid pressure cylinder and a pressure sensor configured to detect a fluid pressure.

According to the aspects of the present invention, it is possible to provide an all solid-state battery unit that can improve energy efficiency by stabilizing the charge and discharge properties in response to fluctuations of temperature and State of Charge of all solid-state battery module.

### BRIEF DESCRIPTION OF THE DRAWINGS

FIG. 1 is a model cross-section view illustrating an all solid-state battery unit of one embodiment of the present invention.

FIG. 2 is a graph illustrating a relationship between the thickness and State of Charge (SOC) of an all solid-state battery cell.

FIG. 3 is a graph illustrating a relationship between an internal resistance and State of Charge (SOC) of an all solid-state battery cell.

FIG. 4 is a graph illustrating a relationship between an internal resistance and temperature of an all solid-state battery cell.

FIG. 5 is a graph illustrating a relationship between an internal resistance and a surface pressure (a load applied to an all solid-state battery cell) of the all solid-state battery cell.

### DETAILED DESCRIPTION OF THE INVENTION

Hereinafter, an all solid-state battery unit of one embodiment of the present invention will be described with reference to the drawings. The embodiment shown below is a specific description to give a better understanding of the intent of the invention and is not intended to limit the invention unless otherwise specified. In the drawings used in the following description, key parts may be enlarged for the sake of convenience in order to make the features of the invention easier to understand, and the dimensional proportions of each component may not be the same as in reality.

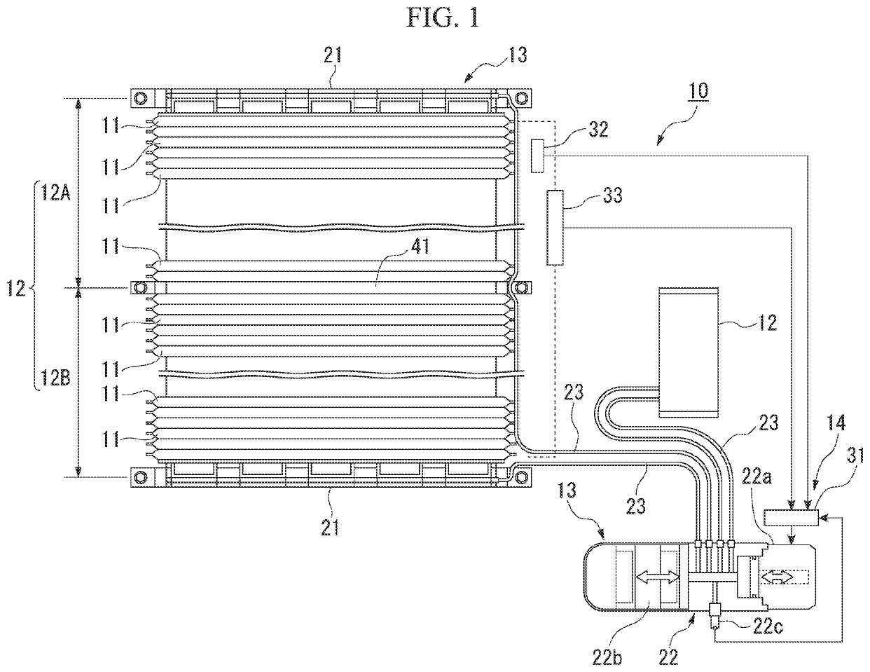

A configuration example of an all solid-state battery unit of one embodiment of the present application will be explained. FIG. 1 is a model cross-section view illustrating an all solid-state battery unit of one embodiment of the present invention. The all solid-state battery unit 10 of the present embodiment has an all solid-state battery module 12 in which a plurality of all solid-state battery cells 11, 11 . . . are laminated, a pressurization unit 13, and a control unit 14.

The all solid-state battery cell 11 may have a configuration similar to a well-known all solid-state battery cell, for example, a configuration wherein a positive electrode laminated body in which a positive electrode mixture layer of a positive electrode layer and a positive electrode solid-state electrolyte layer are pressurized and bonded, and a negative electrode laminated body in which a negative electrode mixture layer of a negative electrode layer and a negative electrode solid-state electrolyte layer are pressurized and bonded, are pressurized and bonded.

The all solid-state battery module 12 is where the plurality of the aforementioned all solid-state battery cells 11 are laminated, in the present embodiment, is configured by a first all solid-state battery module 12A which is formed on one end side across a partition 41 in a center, and a second all solid-state battery module 12B which is formed on the other end side.

Each of the first all solid-state battery module 12A, and the second all solid-state battery module 12B is consisted by a configuration where the same number of the all solid-state battery cells 11, 11 . . . are laminated in a symmetry shape. The plurality of the all solid-state battery cell 11, 11 . . . are mutually electrically connected in parallel. The all solid-state battery module 12 may be accommodated within, for example, a heat transfer property housing (not shown).

The pressurization unit 13 has a fluid pressure cylinder 21 which is formed so as to come in contact with each of the all solid-state battery cells 11a disposed on one end side and the other end side in a lamination direction, a fluid pressure device 22 which pressurizes and decompresses hydraulic fluid which is one example of application and reduction of pressure medium, a pressure-resistant pipe 23 which connects the fluid pressure device 22 and the fluid pressure cylinder 21 and circulates the hydraulic fluid. The fluid pressure device 22 has a pressurization unit 22a, an accumulator (accumulator) 22b, and a pressure sensor 22c. The application and reduction of pressure medium used in the fluid pressure device 22 may be liquid, not limited to the hydraulic fluid, any liquid of which volume fluctuations by application and reduction of pressure are smaller may be used.

The fluid pressure cylinder 21 can pressurize the all solid-state battery cells 11, 11 . . . configuring the all solid-state battery module 12 along the lamination direction by the hydraulic fluid pressurized in the fluid pressure device 22.

The internal resistance of the all solid-state battery cells 11, 11 . . . changes depending on the load (surface pressure) applied from the fluid pressure cylinder 21. More specifically, as the load (surface pressure) applied to the all solid-state battery cells 11, 11 . . . increases, the internal resistance of each of the all solid-state battery cells 11 decreases. On the contrary, as the load (surface pressure) applied to the all solid-state battery cells 11, 11 . . . decreases, the internal resistance of each of the all solid-state battery cells 11 increases. When the internal resistance of the all solid-state battery cell 11 increases, the temperature of the all solid-state battery cell 11 increases by the charging and discharging current.

The fluid pressure device 22 configuring the pressurization unit 13 may be a configuration collectively operating the fluid pressure cylinder 21 formed on each of the plurality of the all solid-state battery modules 12,12. Specifically, the fluid pressure device 22 may be a configuration where pressure-resistant pipes 23 are connected from one fluid pressure device 22 toward the fluid pressure cylinder 21 formed on each of the plurality of the all solid-state battery modules 12,12. According to such configuration, a uniform load (surface pressure) can be applied to plurality of all solid-state battery module 12, 12 by a low cost configuration.

The control unit 14 has, for example, a control circuit portion 31 comprising an interface circuit and the like which controls an operation of the pressurization unit 22a configuring the fluid pressure device 22, a temperature sensor 32 which detects a temperature of the all solid-state battery module 12 and outputs to the control circuit portion 31, and a SOC sensing circuit 33 which detects a State of Charge (SOC) of the all solid-state battery module 12 and outputs to the control circuit portion 31.

The SOC sensing circuit 33 may be, for example, an output voltmeter. The State of Charge (SOC) can be calculated from a change of an output voltage of the all solid-state battery module 12.

The temperature sensor 32 may be formed, for example, at a position coming in contact with the all solid-state battery module 12. A configuration may be adopted where the temperature sensor 32 are formed at the plurality of positions of all solid-state battery module 12 and a temperature distribution can be detected.

The control circuit portion 31 controls a pressure of the hydraulic fluid applying to the fluid pressure cylinder 21 with respect to the pressurization unit 22a depending on the temperature and the State of Charge (SOC) detected by the temperature sensor 32, and the SOC sensing circuit 33 of the all solid-state battery module 12.

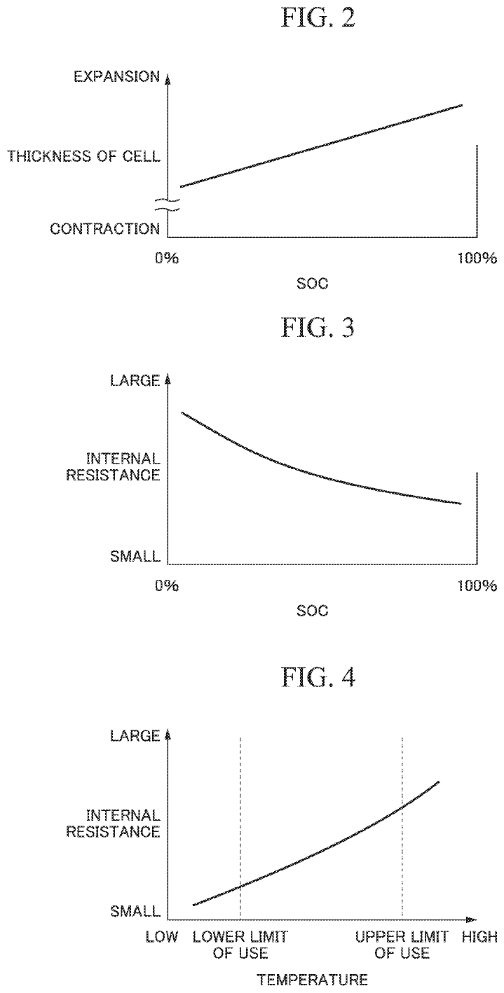

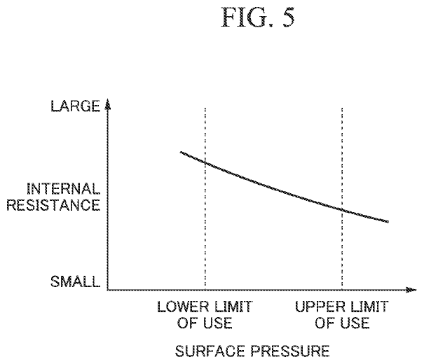

An operation of the all solid-state battery unit 10 of the present embodiment having the above-mentioned configuration will be explained. In the all solid-state battery cell 11, as the State of Charge (SOC) becomes larger, the thickness increases (see the graph in FIG. 2). As the State of Charge (SOC) becomes larger, the internal resistance decreases (see the graph in FIG. 3). Furthermore, when the internal resistance of the all solid-state battery cell 11 increases, the temperature also increases by the charging and discharging current (see the graph in FIG. 4). Furthermore, the relationship between the internal resistance of all solid-state battery cell 11 and the surface pressure (the load applied to the all solid-state battery cell 11) is shown in the graph in FIG. 5. The temperature and the surface pressure of the all solid-state battery cell 11 have appropriate use possible ranges where use upper limits and use lower limits are set.

Based on such knowledge, the control unit 14 controls the load applying to the all solid-state battery cell 11 by controlling the fluid pressure device 22 such that the internal resistance is always optimal in order to suppress loss and fever of the all solid-state battery module 12 at both a charge time and a discharge time.

Specifically, for example, an arbitrary threshold value with respect to the temperature is set, two states of a temperature (low) and a temperature (high) on the border of this threshold value are set, an arbitrary threshold value with respect to the State of Charge (SOC) is set, and two states of a SOC (small) and a SOC (large) on the border of this threshold value are set.

Then, the control unit 14 performs a control shown in Table 1 depending on values of a temperature (binary) of the all solid-state battery module 12 obtained by the temperature sensor 32 and a State of Charge (binary) obtained by the SOC sensing circuit 33. The control in Table 1 shown below is one example, and a specific control is not limited to this control.

TABLE 1

| | | CHARGE RATE SOC | |
|---|---|---|---|
| | | SMALL | LARGE |
| TEMPERATURE | HIGH | ▪AT CHARGE TIME, DISCHARGE | ▪AT CHARGE TIME, DISCHARGE |
| | | TIME: | TIME: |
| | | SINCE CELL CONTRACTS, INCREASE | SINCE CELL EXPANDS, MAINTAIN |
| | | SURFACE PRESSURE WITHIN RANGE | HIGHER SURFACE PRESSURE NOT |
| | | NOT EXCEEDING UPPER LIMIT. | SO AS TO EXCEED UPPER LIMIT. |
| | | →INCREASE LOAD APPLYING TO | →INCREASE LOAD APPLYING TO |
| | | ALL SOLID-STATE BATTERY CELL BY | ALL SOLID-STATE BATTERY CELL |
| | | INCREASING PRESSURE UNIT. | BY INCREASING PRESSURE UNIT. |
| | LOW | ▪AT CHARGE TIME: | ▪AT CHARGE TIME: |
| | | SINCE INTERNAL RESISTANCE IS | SINCE CHARGE SPEED MAY BE |
| | | REQUIRED TO BE DECREASED BY | LATE IN ORDER TO IMPROVE |
| | | INCREASING TEMPERATURE IN | EFFICIENCY, OPERATE SURFACE |
| | | ORDER TO INCREASE CHARGE | PRESSURE HIGHER. |
| | | SPEED, OPERATE TO INCREASE | →INCREASE LOAD APPLYING TO |
| | | TEMPERATURE BY SELF FEVER. | ALL SOLID-STATE BATTERY CELL |
| | | →DECREASE LOAD APPLYING TO | BY INCREASING PRESSURE UNIT. |
| | | ALL SOLID-STATE BATTERY CELL BY | ▪AT DISCHARGE TIME: |
| | | INCREASING PRESSURE UNIT. | IN CASE OF PRIORITY ON |
| | | ▪AT DISCHARGE TIME: | EFFICIENCY, OPERATE SURFACE |
| | | OPERATE SURFACE PRESSURE | PRESSURE HIGHER. |
| | | HIGHER IN ORDER TO INCREASE | IN CASE WHERE OUTPUT IS |
| | | DISCHARGE. | REQUIRED, OPERATE SURFACE |
| | | →INCREASE LOAD APPLYING TO | PRESSURE SLIGHTLY LOWER IN |
| | | ALL SOLID-STATE BATTERY CELL BY | ORDER TO INCREASE |
| | | INCREASING PRESSURE UNIT. | TEMPERATURE. |
| | | | →DECREASE LOAD APPLYING TO |
| | | | ALL SOLID-STATE BATTERY CELL |
| | | | BY INCREASING PRESSURE UNIT. |

According to the execution of the above controls by operating the fluid pressure device 22, the internal resistance of the all solid-state battery cell 11 can be kept always optimal depending on each states of the temperature and the State of Charge of the all solid-state battery module 12. As a result, the charge and discharge properties can always be stabilized in response to the change of the temperature and the State of Charge of the all solid-state battery module 12.

As above, according to the all solid-state battery unit 10 of one embodiment of the present application, the internal resistance of the all solid-state battery cell is controlled so as to maximize a charge property at a charge time and a discharge property at a discharge time depending on the states such as temperature and State of Charge (SOC) of the all solid-state battery module. As a result, an all solid-state battery unit which is always stabilized even if the temperature and the State of Charge are changed can be realized.

In the above-mentioned embodiment, a load applying to the all solid-state battery cell 11 is controlled by detecting both of the temperature and the State of Charge (SOC) of the all solid-state battery module 12. However, a configuration may be adopted where a load applying to the all solid-state battery cell 11 is controlled by detecting either one of the temperature and the State of Charge (SOC) of all solid-state battery module 12, and the internal resistance is controlled to be always minimum.

In the above-mentioned embodiment, for simplifying the configuration of the control circuit portion 31, both of the temperature and the State of Charge (SOC) of all solid-state battery module 12 are controlled by binary on the border of one set threshold value. However, it may be controlled by multiple values where the plurality of threshold values are set or controlled by continuous value.

The above described embodiments of the invention are presented as examples and are not intended to limit the scope of the invention. These embodiments can be implemented in various other forms, and various omissions, substitutions, and modifications can be made without departing from the gist of the invention. These embodiments and variations thereof are included within the scope of the claims and their equivalents as well as within the scope and gist of the invention.

### INDUSTRIAL APPLICABILITY

The all solid-state battery unit of the present invention can realize an all solid-state battery unit, which is always stabilized even if the temperature and the State of Charge are changed, by controlling the internal resistance of the all solid-state battery cell so as to maximize a charge property at a charge time and a discharge property at a discharge time depending on the states such as temperature and State of Charge (SOC) of the all solid-state battery module. Such all solid-state battery unit can improve energy efficiency when using as a secondary battery of a vehicle such an EV and a HEV. Consequently, the present invention has an industrial applicability.

What is claimed is:

1. An all solid-state battery unit comprising:
a battery module in which a plurality of all solid-state battery cells are laminated;
a pressurization unit configured to pressurize the battery module; and
a control unit configured to control the pressurization unit,
wherein the control unit controls a pressurization force of the pressurization unit depending on either or both of a temperature of the battery module and a State of Charge of the battery module.

2. The all solid-state battery unit according to claim 1,
wherein the control unit performs a control of decreasing the pressurization force of the pressurization unit in response to a decrease of the temperature of the battery module.

3. The all solid-state battery unit according to claim 1,
wherein the control unit performs a control of increasing the pressurization force of the pressurization unit in response to a decrease of the State of Charge of the battery module.

4. The all solid-state battery unit according to claim 1,
wherein the control unit has a fluid pressure cylinder and a pressure sensor configured to detect a fluid pressure.
